(19) United States
(12) Patent Application Publication
(10) Pub. No.: US 2010/0310816 A1
(43) Pub. Date: Dec. 9, 2010

(54) DEVICE FOR MAKING ANNOTATIONS ON A BACKING

(76) Inventor: Genaro Aldrete-Frances, Jalisco (MX)

Correspondence Address: BROWDY AND NEIMARK, P.L.L.C.;624 NINTH STREET, NW, SUITE 300, WASHINGTON, DC, 20001-5303, US

(21) Appl. No.: 12/681,135

(22) PCT Filed: Sep. 30, 2008
(86) PCT No.: PCT/IB2008/002555

§ 371 Date: Aug. 24, 2010

(30) Foreign Application Priority Data
Oct. 1, 2007 (MX) MX/U/2007/000366

(51) Int. Cl. B32B 3/26; B32B 3/06

(52) U.S. Cl. 428/100; 428/314.4

(57) ABSTRACT

A device to make annotations on a removable or fixed background is described, over which it is desirable to make annotations leaving it intact; When the background is removable, the device comprises an upper transparent and smooth film, with closed pores to make annotations with dry erase markers and a back cover attached to the upper film leaving an inlet through which the background is inserted, such as pre-printed sheets or radiographies. When the background is fixed, the device also has a mounting tab to be placed on said background.

### FIELD OF THE INVENTION

The present invention is related to the techniques used in designing and manufacturing writing surfaces to be used with dry erase markers, and more particularly, is related to a device to make annotations on a background that does not want to be altered, for example, sheets of books, formats, receipts, material that is written or drawn on a blackboard, etc.

### BACKGROUND OF THE INVENTION

As it is well known, there is a great variety of surfaces destined to writing and drawing, which can be erased so that surfaces can be used once and again. Such is the case of traditional blackboards which are a flat surface, usually green or black colored where in order to make annotations, a chalk is used, which is made up of oxides, hydroxides, and calcium carbonate in order to leave small particles adhered to the surface. Traditional blackboards have the drawback of being an opaque surface, besides they can not be transported from one place to another, and above all, they have the drawback that the chalk looses particles that are noxious for the person who is making annotations and erases the same.

Currently, different surfaces have been trying to be obtained where lines could be made in order to be reused, that is the case of the U.S. Pat. No. 3,574,956 where a writting support is described which is made up from a transparent or translucent plastic sheet, for example, PVC, which front surface is embossed with lines of semi-spherical bulges with about 0.1 mm in diameter and a space therebetween equal or smaller than the diameter. The back surface of the sheet has a grid with a layer with a distinctive color. In this support, any instrument that leaves solid particles on the surface can be used, having the drawback that the writing principle is similar to the one made in a traditional blackboard.

White blackboards with a smooth free-porosity and specific roughness surface designed to be used with ink markers with felt point do exist too, specifically for those dry erasure blackboards which can be purchased in the Mexican market under the trademark Pintarron®; however, a frequent problem in the blackboard use for dry erase markers as well as in traditional blackboards is that in many occasions, in order to cause an impact and an effective communication about what is being taught or explained, it is needed making annotations on something that is already written or drawn, without altering it in some way.

Likewise, there are semi-transparent surfaces wherein lines are drawn erasing and writing them in the same surface several times, such is the case of the U.S. Pat. No. 4,051,609 where a manufacture method of a reusable writing board and product thereof is described which provides an improvement in the manufacture of the so called “magic blackboards” through a printing operation. A background surface is provided in the same piece of cardboard, a bending and gluing operation produces the blackboard with a decorative, stuck, extendible panel protecting the entire upper plastic edge of a plastic sheet that covers the printed surface on the background, pneumatic means are used to separate the films and to erase in this way the stuck lines instantly raising the surface; nevertheless, this magic blackboard has the drawback that no annotations can be made with a dry erase marker to highlight something that has been written or drawn.

In U.S. Pat. No. 5,599,189, a reusable auxiliary board of learning is described, since it allows the student to insert a work sheet within a rigid body having a space between two plans mounted at the same time on a frame, one of the planes is transparent allowing the instructor to mark therein, carrying out the work required by an underlying work sheet, the marks made by the instructor are erased and the student tries to do the same work. A work sheet is fixed in position through a clipboard, it is mounted in a slot in order to avoid scratches on the transparent panel, the clipboard is attached in the slot by a latch mechanism, giving the capability of drawing over the documents without modifying the original one. However, the invention described in said document does not consider the manufacture of planes of flexible materials and the back transparent panel, as well as not adding elements to fix the board on a surface.

Another surface which is used to draw and which is reusable is the product obtained in the U.S. Pat. No. 5,791,910, since it is a reusable writing board with a single polyester coating sheet, reusable writing boards usually include two films placed on top of a back up board with a wax layer to which the films stick through an instrument that presses causing a dark colored pattern, the elements that make it up are a back up member which front side is printed with background color coated with a wax layer and a whitish polyester layer suitable as writing surface to provide a translucent opaque effect. Written is erased on lifting the upper film made up of polyester; likewise, it includes graphic material as lines, maps, or other pre-printed information in the back part of the film. Nonetheless, the chance of exchanging a background with pre-printed work material by another one is not taken into account and does not allows the use of dry erase markers either.

A flexible blackboard for graphic use is described in the Mexican utility model No. MX 1545. which is a rectangular set of three superimposed layers, plastic-paper-plastic, in one single piece, made up of a first layer defined by a paper sheet coated by two plasticized layers; a plurality of metallic buttonholes with just one intermediate radius each; an intermediate perforation that goes through the blackboard thickness and which are placed within the limit adjacent to the corners of the rectangle; a plurality of removable magnetic bolts with two inserted cylindrical bodies, a first body of the same size of the intermediate hole of the buttonholes allowing that said first body slides through said hole and a second body of greater size than the first one that is suitable as a limit when the first body is inserted in the hole of the buttonhole, said bolts, being magnetic, allow the blackboard to be attached in metallic surfaces. Again, here is a drawback of not having a surface that allows making annotations over something already written or drawn.

In short, it can be seen that there are many devices to show knowledge by drawing and writing on top of traditional blackboards, white surface blackboards, boards, flipcharts, etc. However, a constant problem and need is that in order to efficiently communicate some knowledge, sometimes it is necessary to make annotations, marks, lines, etc. on what is written or printed without altering it; that is, providing a surface or mask that is placed on or receives a background to make annotations on it without modifying what is underneath thereof.

### SUMMARY OF THE INVENTION

As a consequence of the above, cutting out the current drawbacks in the devices and articles that are suitable to show written or graphic material has been sought, developing a device to make annotations on a background. The device, being simple, but very practical, functional, and of easy manufacture that allows making annotations on a background that can be fixed or exchangeable.

The device of the present invention comprises an upper transparent and smooth film, with closed pores to make annotations with dry erase markers, the film is manufactured from a polymer; and, a back cover wherein the upper film is attached in at least one portion of its perimeter, in such a way that between the upper film and the back cover there is an inlet that allows the insertion and removal of the background on which is desirable to make annotations without altering it. That is, the background is removable.

In a device embodiment, it comprises means to attach the back cover on a surface, such as a wall, a door, or an electrical appliance.

The device is very useful when, for example, the background is a pre-printed sheet, a format, a form, a drawing, a sketch or a diagram, or a representation of a field of any sport, since it allows making annotations without damaging or altering the background.

The polymer with which the upper film is manufactured is selected from the group that consists of acetate, acrylic, PVC, polyurethane, melamine, polystyrene, polyethylene, polypropylene, polyethylene-terephtalate, polyester, and polyvinyl. In this sense, the back cover can also be transparent and be manufactured with the same material of the upper film; that is, making annotations can also be done on the back cover.

Now, as it was mentioned, the background on which annotations want to be made, can be fixed, in this case, the device of the present invention comprises: an upper transparent and smooth film, with closed pores to make annotations with dry erase markers, the film being manufactured from a polymer; and, a mounting tab attached to a portion of the upper film perimeter, the mounting tab is placed on the surface of the fixed background where annotations want to be made leaving it intact.

This embodiment mounted on a fixed background is very useful when annotations want to be made on what is already written or drawn on a traditional blackboard or a white surface one, a flipchart, a book, a binder, or a magazine, etc.

From the abovementioned, an object of the present invention is to provide an easy manufacture and cheap device that could be used over the majority of the surfaces where there is written or drawn material and above all, in those documents that do not want to be altered.

### BRIEF DESCRIPTION OF THE DRAWINGS

The novel aspects considered as typical of the present invention, will be particularly established in the attached set of claims. Nevertheless, the invention itself, both for its structure and for its mounting, along with other objects and advantages thereof, will be better understood in the following detailed description of certain preferred embodiments, when reading with regard to the accompanying drawings, wherein:

FIG. 1 is an upper perspective view of a device to make annotations on a background, built according to a first preferred embodiment of the present invention, wherein the background is removable and it is a pre-printed sheet.

FIG. 2 is a perspective view of the device to make annotations on a background, wherein the device is built according to a second preferred embodiment of the present invention and it is mounted in a box to observe radiographies.

FIG. 3 is a front view of the device to make annotations on a background, built according to a third preferred embodiment of the present invention, wherein the device is removably placed on an electric appliance.

FIG. 4 is an upper perspective view of the device to make annotations on a background, built according to a fourth preferred embodiment of the present invention, wherein the back cover is rigid.

FIG. 5 is a perspective view of the device to make annotations on a background, built according to a fifth preferred embodiment of the device of the present invention, the device being placed on a monitor.

FIG. 6 is a perspective view of the device to make annotations on a background, built according to a sixth preferred embodiment of the present invention, wherein the background is fixed and it is in a binder.

FIG. 7 is a perspective view of the embodiment illustrated in FIG. 6, being used on a book.

FIG. 8A is a perspective view of the embodiment of the invention illustrated in FIG. 6 before being placed on a blackboard.

FIG. 8B is a perspective view of the device of FIG. 8A once the device has been placed on the blackboard.

FIG. 9A is a perspective view of the embodiment of the invention illustrated in FIG. 6 before being placed on a flipchart.

FIG. 9B is a perspective view of the embodiment of the device of FIG. 9A once it is placed on the flipchart.

### DETAILED DESCRIPTION OF THE PREFERRED EMBODIMENTS OF THE INVENTION

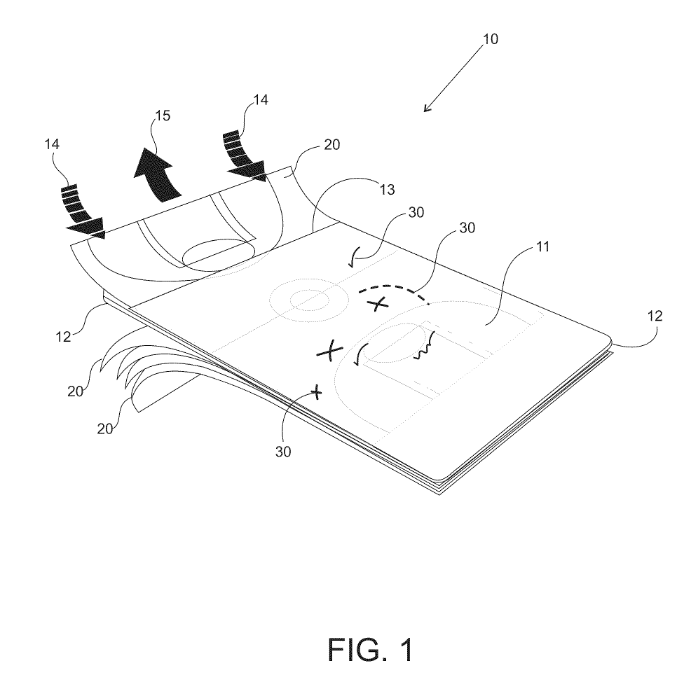

In reference to the attached drawings, and more specifically to FIG. 1 thereof, a perspective view of a device to make annotations on a background referred with number 10, wherein a removable background in form of sheets 20 of specific format is inserted, such as diagrams of soccer fields, basketball fields, staves, maps, educational formats, etc., or pre-printed sheets for multiple use in companies as bulletins, parity, menu, schedules, etc.

The device 10 comprises an upper film 11 which is transparent, smooth and with closed pore to make annotations with dry erase markers, this film is manufactured from a polymer which is selected from the group comprising acetate, acrylic, PVC, polyurethane, melamine, polystyrene, polyethylene, polypropylene, polyethylene-terephtalate, polyester and polyvinyl.

As it is observed, the device has a back cover 12 wherein the upper film 11 is attached in a portion of its perimeter in such a way that between the upper film 11 and the back cover 12, there is an inlet 13 that allows the insertion and removal of the sheets 20, as it is indicated by the moving arrows 14 and 15. It is just on this sheets 20 on which annotations 30 that not alter the content of the sheets want to be written. As it is observed, the upper film 11 and the back cover 12 have quadrilateral shape, however, the device of the present invention may have any shape, for example, an oval shape; the shape does not imply a restriction for the present invention, that is, other shapes are possible.

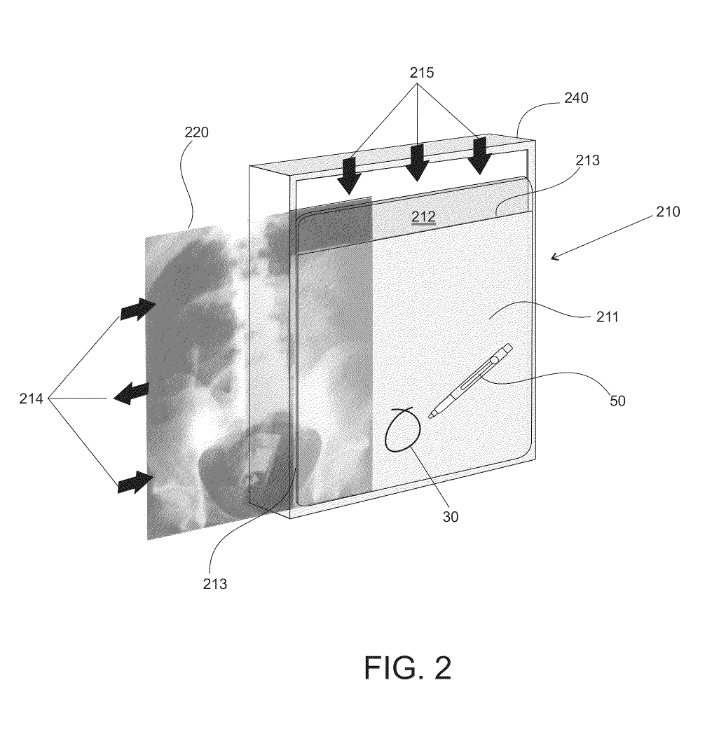

Now, reference is made to FIG. 2 in order to show a second preferred embodiment of the present invention, for this and the following embodiments, a digit on the left is added in the numerical reference of common elements regarding the first embodiment, for example, the device of FIG. 2 is identified with number 210, and the upper film 211 which is smooth and transparent is seen therein and the back cover 212 attached to the perimeter of the upper film 211 leaving at least one inlet 213.

This second embodiment is characterized in that the back cover 212 is translucent so that light can pass through it on mounting the device 210 on a box of lamps or “backlight” 240, even the back cover 212 can be made up of the same material as the upper film 211, that is, annotations 30 can be made on the upper film 211 as well as on the back cover 212. The device 210 of this second embodiment allows introducing a radiography 220 as removable background, in such a way that on inserting the radiography 220 in the device 210 and on turning on the light, the doctor who is analyzing the radiography can make annotations 30 with a dry erase marker 50. Subsequently, annotations 30 can be erased in order to use the device 210 once and again on other radiographies without modifying or damaging the content thereof. The moving arrows 214 and 215 show the direction to which the radiography slides within the device 210 inserting itself laterally or vertically at the corresponding inlets 213.

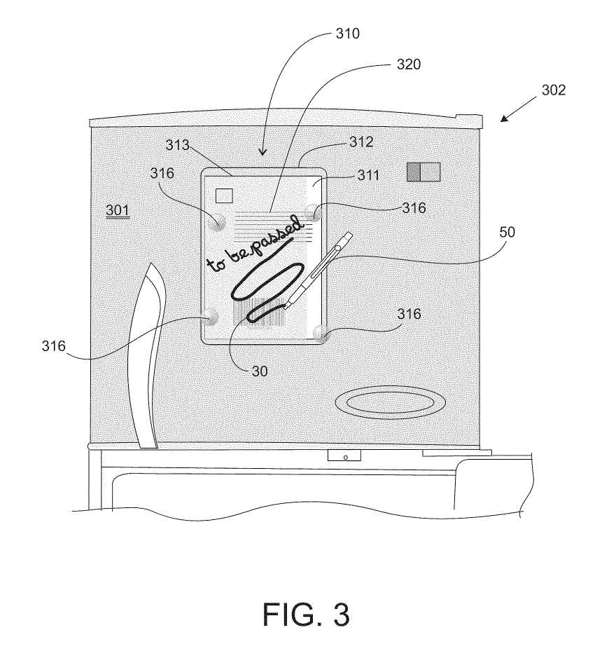

Referring now to FIG. 3, a third embodiment of the device of the present invention is shown, said third embodiment is identified with number 310, wherein the upper film 311, the back cover 312 attached to the perimeter of the upper film 311, and forming an inlet 313 to insert through it a background in a receipt shape 320 or in a photograph or sheet shape can be observed. Annotations 30 are made with the dry erase marker 50 without damaging the receipt 320.

Now, in this third embodiment, the device 310 includes means to attach the back cover on a surface such as it is shown in FIG. 3, where the surface is the upper door 301 of the refrigerator 302. This attaching means are particularly the magnets 316; however, other means can be used with the same purpose such as Velcro® (hook-and-fiber attachment strips), adhesive strip, etc.

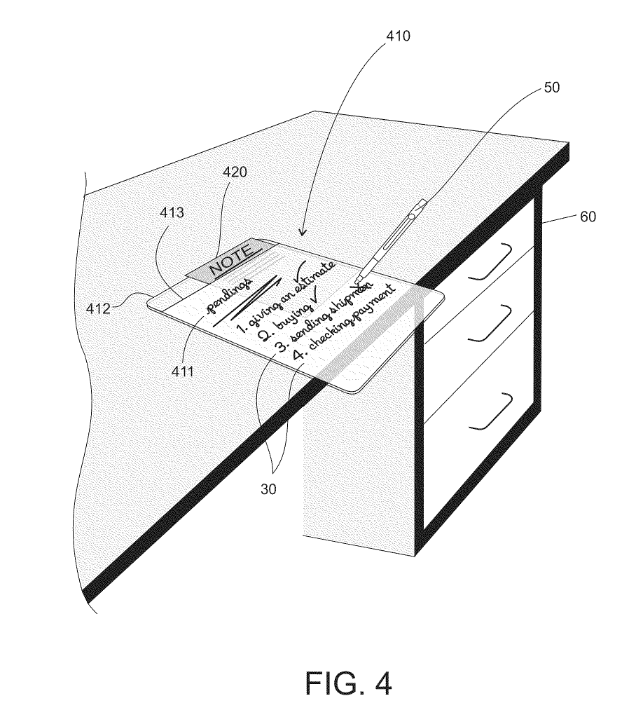

Another embodiment of the device where the background is removable is illustrated in FIG. 4, in this fourth embodiment, the device is identified with number 410, wherein the transparent upper film 411, the back cover 412 attached to the majority of the perimeter of the upper film 411 leaving an inlet 413 for the insertion and removal of a background which in this case is a sheet of annotations 420 can be observed. In this embodiment, the back cover 412 is rigid and besides, it can be transparent. Annotations 30 are made with the dry erase marker 50. As it is observed, the device 410 turns out to be portable and could be used on a desk 60.

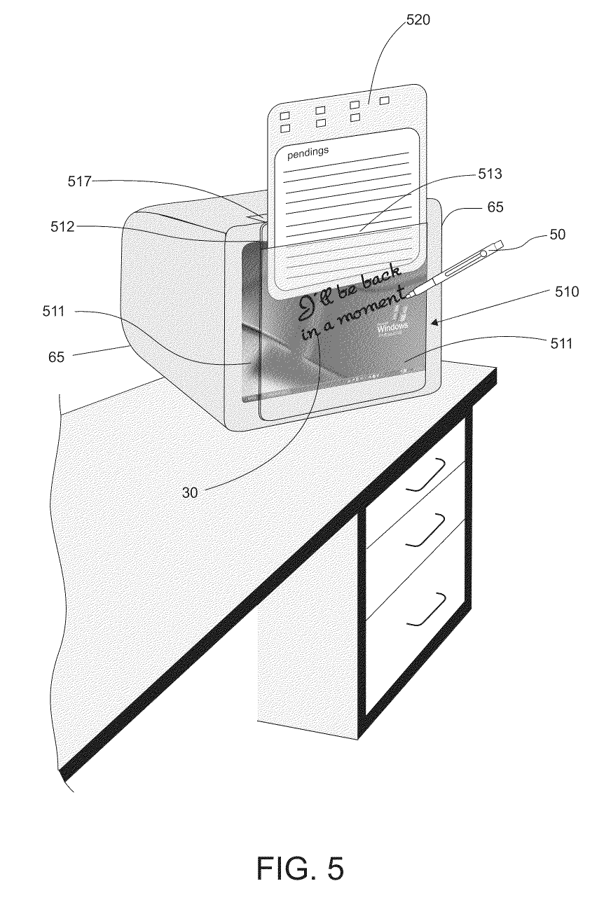

FIG. 5 shows a fifth embodiment of the device to make annotations on a background of the present invention, which is identified with number 510, the device is built by the upper film 511, the back cover 512 attached to the perimeter of the upper film 511 leaving an inlet 513. The upper film 511 is transparent, smooth and with closed pore in order to use a dry erase marker 50 on it to make annotations 30. Through the inlet 513 of the device 510, a sheet of pending work 520 can be inserted. In this fifth embodiment, the back cover 512 is transparent.

Moreover, this fifth embodiment comprises an mounting tab 517 attached to the back cover 512 that allows attaching the device 510 on the monitor 65 of a computer, the mounting tab 517 can be made up of adhesive material or Velcro® type strip (hook-and-fiber attachment strips).

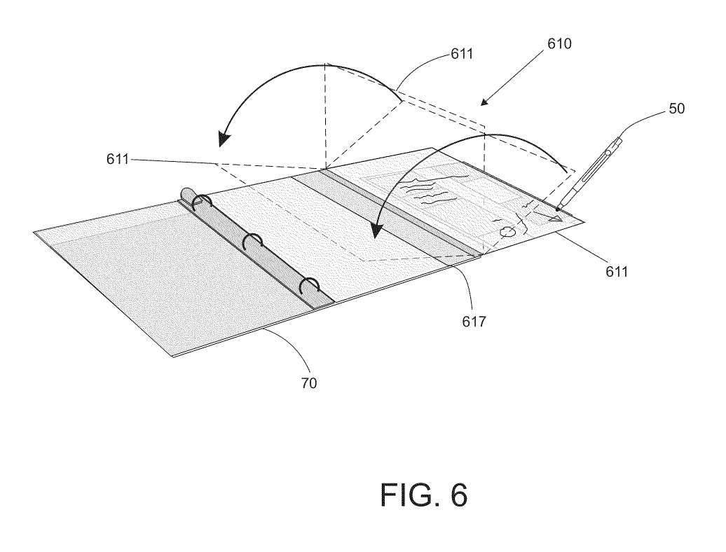

Until now, in FIGS. 1 to 5, those embodiments where the background is removable have been illustrated and described. Nevertheless, in the present invention, covering those needs where the background is fixed has been considered, such as a book, an agenda, or a traditional blackboard or a white surface one, wherein the device has been designed to cover this need, that is, to mount on said background and in this way, make annotations. In this sense, reference is made to FIG. 6, which shows a sixth embodiment identified with number 610, which is made up of an upper film 611 which is transparent, smooth and with closed pore and an mounting tab 617 attached to a portion of the perimeter of the upper film 611, this tab 617 can be made up of adhesive material or Velcro® type tape. The mounting tab 617 is flexible and it extends backwards and in parallel to the upper film 611 when placing the device on the background which in this case is a binder 70, the tab 617 has such a size that allows mounting the device on the binder 70. The upper transparent film 611 is designed to be used with a dry erase marker 50.

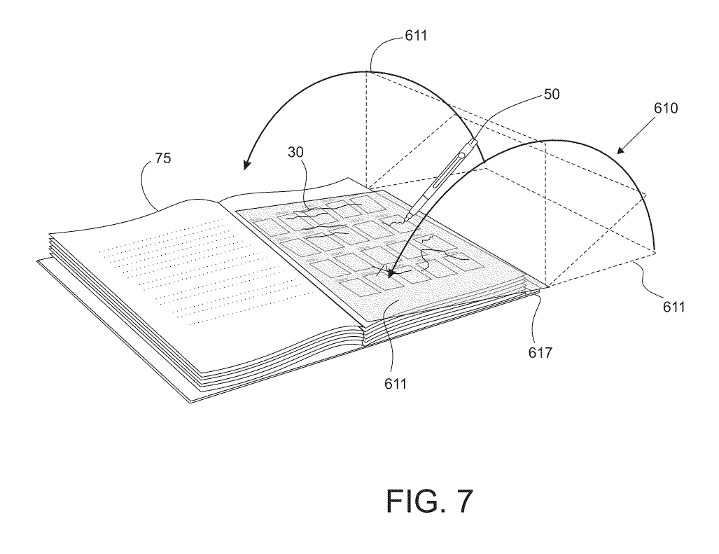

In FIG. 7, the same embodiment of FIG. 6 is illustrated, being now used on a book 75. References 611 and 617 identify the above described upper transparent film and the mounting tab respectively. As it can be observed, this embodiment also allows making annotations 30 with the dry erase marker 50.

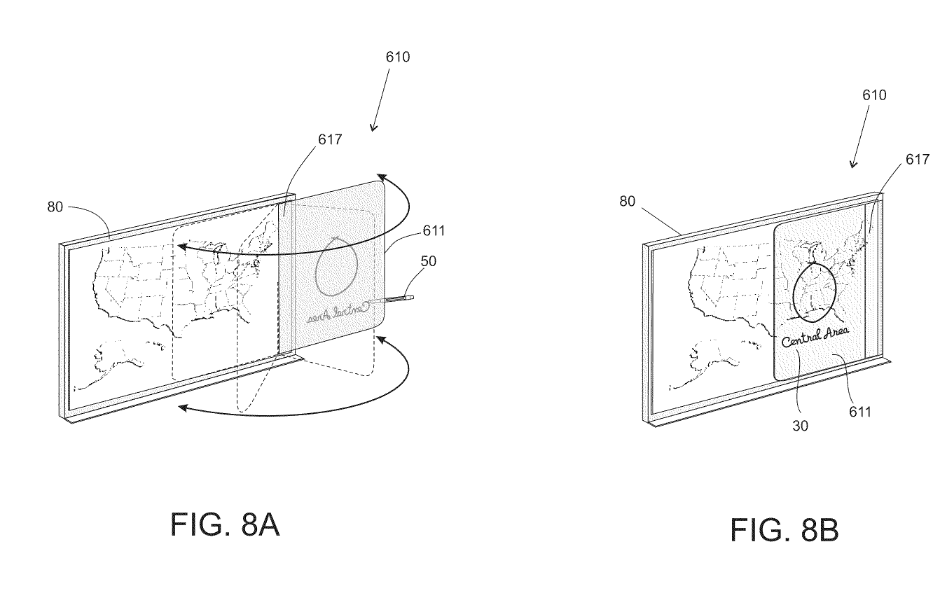

To see that the present invention has multiple applications and advantages, reference is made to FIGS. 8A and 8B, where it can be seen the device 610 of the sixth embodiment being used on a blackboard 80 that can be a traditional one or a white surface one. The mounting tab 617 extends backwards and in parallel to the upper film 611 in such a way that it allows the film 611 to hingedly move on the mounting tab 617. Annotations 30 are made with the dry erase marker 50. The film 611 can cover a portion or the totality of the blackboard 80.

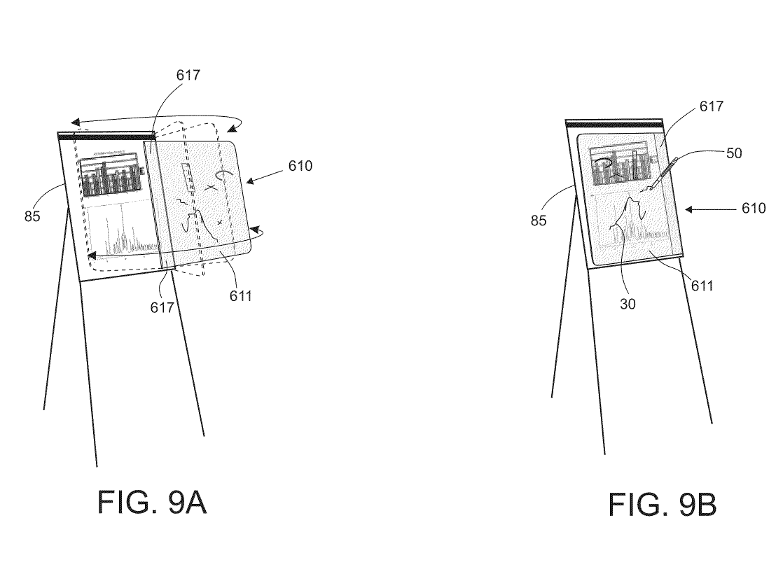

FIGS. 9A and 9B again show one more application of the identified embodiment with number of reference 610 made up by the mounting tab 617 and the upper film 611 attached to it, the device 610 is mounted on a flipchart 85. The device 610 of the sixth embodiment is very useful to make annotations 30 using the dry erase marker 50 improving the exposure of what is written or drawn on the flipchart 85. The upper film covers a portion or the entire flipchart 85.

Finally, it could be said that the upper transparent and smooth film, with closed pores of all embodiments of the device to make annotations on a background of the present invention is manufactured from a polymer selected from the group comprising acetate, acrylic, PVC, polyurethane, melamine, polystyrene, polyethylene, polypropylene, polyethylene-terephtalate, polyester, and polyvinyl, the back cover is made up of a material which is selected from a great variety of materials, for example plastic, wood, metal, melamine, etc.

Even though reference has been made to specific embodiments of the present invention in the prior description, it has to be emphasized that many possible modifications could be done to such embodiment, but without deviating from the real scope of the invention, such as the materials, sizes, location, etc. Therefore, the present invention must not be restricted except for the established in the prior art and by the attached set of claims.

1. A device to make annotations on a background, comprising:
a) an upper transparent and smooth film, with closed pores in order to make annotations with dry erase markers, the film being manufactured from a polymer; and,
b) a back cover wherein the upper film is attached in at least a portion of its perimeter, such that between the upper film and the back cover there exists an inlet that allows the insertion and removal of the background on which annotations want to be made, thereby leaving the same intact.

2. A device to make annotations on a background, according to claim 1, further characterized because it comprises means to attach the back cover on a surface.

3. A device to make annotations on a background, according to claim 2, further characterized because the attaching means are a mounting tab joined to the back cover.

4. A device to make annotations on a background, according to claim 3, further characterized because the mounting tab is made up of a material selected from the group consisting of hook-and-fiber attachment strips, magnets and adhesive strips.

5. A device to make annotations on a background. According to claim 2, further characterized because the surface is a wall, a door or an electrical appliance.

6. A device to make annotations on a background, according to claim 1, further characterized because the back cover is transparent or translucent.

7. A device to make annotations on a background, according to claim 6, further characterized because the back cover is translucent and through the inlet of said device a radiography can be inserted, the back cover allowing light to pass through in order to notice the contents of the radiography.

8. A device to make annotations on a background, according to claim 1, further characterized because the back cover is rigid.

9. A device to make annotations on a background, according to claim 1, further characterized because the background is a pre-printed sheet with a format, a form, a drawing, a sketch or a diagram.

10. A device to make annotations on a background, according to claim 1, further characterized because the upper film and the back cover have the shape of a quadrilateral.

11. A device to make annotations on a background, according to claim 1, further characterized because the polymer of the upper film is selected from the group consisting of acetate, acrylic, PVC, polyurethane, polystyrene, polyethylene, polypropylene, polyethylene terephthalate, polyester and polyvinyl.

12. A device to make annotations on a background, characterized because it comprises:
a) an upper transparent and smooth film, with closed pores in order to make annotations with dry erase markers, the film being manufactures from a polymer; and,
b) a mounting tab, wherein the upper film is attached in at least a portion of its perimeter, the mounting tab being placed on a fixed background where annotations want to be made, thereby leaving the same intact.

13. A device to make annotations on a background, according to claim 12, further characterized because the tab extends backwards and in parallel to the upper film.

14. A device to make annotations on a background, according to claim 12, further characterized because the mounting tab is sized such that it allows the device to be placed in a binder.

15. A device to make annotations on a background, according to claim 12, further characterized because the upper film is sized such that it covers a portion of a blackboard or of a flipchart, wherein the tab is placed on the blackboard or flipchart.

16. A device to make annotations on a background, according to claim 12, further characterized because said background is one sheet from an agenda.

17. A device to make annotations on a background, according to claim 12, further characterized because said background is a sheet from a book.

18. A device to make annotations on a background, according to claim 12, further characterized because annotations can be made on both faces of the upper film with a dry erase marker.

19. A device to make annotations on a background, according to claim 12, further characterized because the polymer of the upper film is selected from the group comprising acetate, acrylic, PVC, polyurethane, melamine, polystyrene, polyethylene, polypropylene, polyethylene terephthalate, polyester and polyvinyl.
